(19) United States
(12) Patent Application Publication
(10) Pub. No.: US 2025/0211566 A1
(43) Pub. Date: Jun. 26, 2025

(54) AVOIDING COLLISIONS WITHOUT AP COORDINATION

(71) Applicant: Cisco Technology, Inc., San Jose, CA (US)

(72) Inventors: Domenico FICARA, Essertines-Sur-Yverdon (CH); Javier I. CONTRERAS ALBESA, Sant Cugat del Valles (ES); Juan Carlos ZUNIGA, Montreal (CA); Jerome HENRY, Pittsboro, NC (US); Ugo M. CAMPIGLIO, Morges (CH)

(21) Appl. No.: 18/662,777

(22) Filed: May 13, 2024

Related U.S. Application Data
(60) Provisional application No. 63/614,527, filed on Dec. 23, 2023.

(51) Int. Cl. H04L 61/5046; H04L 101/622; H04W 12/0471; H04W 60/06; H04W 84/12

(52) U.S. Cl. CPC H04L 61/5046; H04W 12/0471; H04W 60/06; H04L 2101/622; H04W 84/12

(57) ABSTRACT

Embodiments herein describe a station identifying itself to an AP's basic service set (BSS). In joining with a BSS of the AP, the station identifies itself with an identifiable random access medium access layer (MAC) address (IRM). The AP saves a combination of an ID of the BSS and the IRM as the current BSSID and the current IRM. The AP handles an exchange protocol with the station in which a next IRM and a next BSSID are provided and become the current IRM and BSSID. The AP disassociates with the station, and when the station rejoins with the access point, the AP determines whether the saved combination matches the IRM and BSSID provided by the station. Communication with the station is successful if there is a match to the current IRM and BSSID combination. Thus, the IRM can be different each time the station rejoins the AP.

### CROSS-REFERENCE TO RELATED APPLICATIONS

This application claims benefit of co-pending U.S. provisional patent application Ser. No. 63/614,527 filed Dec. 23, 2023. The aforementioned related patent application is herein incorporated by reference in its entirety.

### TECHNICAL FIELD

Embodiments presented in this disclosure generally relate to the authentication and association of a station with an access point (AP) in a wireless network. More specifically, embodiments disclosed herein relate to avoiding collisions in the identifiable random access medium access layer (MAC) address (IRM) chosen by a non-AP station during the authentication and association with an AP.

### BACKGROUND

In order for a station to operate with a particular AP in an extended service set (ESS), the station is first required to securely establish its identity with the AP, after which the station is required to associate with the AP to gain full access to the wireless network. The station and AP participate in an exchange protocol as part of an authentication protocol to establish the station's identity with the AP. In one version of the exchange protocol, the AP provides to the station an identifier that the station can use to identify itself upon a subsequent association with the AP. Thus, the identifier is under the control of the AP.

In another version of the protocol, the station indicates in a message of the exchange protocol an identifiable random medium access layer (MAC) address (IRM) that it intends to use upon a subsequent association. However, within an ESS and without coordination, there is a risk of collision with respect to the IRMs.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an ESS infrastructure, according to embodiments.

FIG. 2 depicts a representative architecture of an access point (AP), according to embodiments.

FIG. 3 depicts a management frame, according to embodiments.

FIG. 4 depicts association request and response frames, according to embodiments.

FIG. 5A depicts a flow of operations at the AP as part of the authentication protocol of a station with the AP, according to embodiments.

FIG. 5B depicts a flow of operations at the station as part of the authentication of a station with the AP, according to embodiments.

FIG. 6 depicts a flow of operations at the AP, according to embodiments.

FIG. 7 depicts a flow of operations at the AP, according to embodiments.

FIG. 8 depicts a flow of operations at a station, according to embodiments.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a method of identifying a station in an extended service set (ESS). The method includes: joining the station to a basic service set (BSS) of an access point (AP) using an ID of the BSS (BSSID) and an identifiable random access medium access layer (MAC) address (IRM); saving the BSSID and the IRM as a current BSSID and a current IRM, the saved BSSID and the saved IRM being a saved combination; handling an exchange protocol with the station using the current BSSID and the current IRM, where the exchange protocol includes a next IRM and a next BSSID as the current IRM and current BSSID, respectively; disassociating the station; joining the station to the current BSSID and the current IRM when the current IRM and current BSSID match the saved combination; saving the BSSID and the IRM as the current BSSID and the current IRM, the saved BSSID and the saved IRM being the saved combination; handling an exchange protocol with the station using the current BSSID and current IRM, where the exchange protocol includes a next IRM and next BSSID as the current IRM and the current BSSID, respectively; and disassociating the station.

Another embodiment presented in this disclosure is an access point (AP) in an extended service set. The AP includes a processor and a memory coupled to the processor and having loaded therein a program executable by the processor to: join a station to a basic service set (BSS) of an access point (AP) using an ID of the BSS (BSSID) and an identifiable random access medium access layer (MAC) address (IRM); save the BSSID and the IRM as a current BSSID and a current IRM, the saved BSSID and the saved IRM being a saved combination; handle an exchange protocol with the station using the current BSSID and the current IRM, where the exchange protocol includes a next IRM and a next BSSID as the current IRM and current BSSID, respectively; disassociate the station; join the station to the current BSSID and the current IRM when the current IRM and the current BSSID match the saved combination; save the BSSID and the IRM as the current BSSID and the current IRM, the saved BSSID and the saved IRM being the saved combination; handle an exchange protocol with the station using the current BSSID and current IRM, where the exchange protocol includes a next IRM and next BSSID as the current IRM and the current BSSID, respectively; and disassociate the station.

Yet another embodiment presented in this disclosure is a non-transitory computer-readable medium encoding instructions, which, when executed by a processor of an access point (AP) coupled to a wireless medium, cause the AP to: receive a request to: join a station to a basic service set (BSS) of an access point (AP) using an ID of the BSS (BSSID) and an identifiable random access medium access layer (MAC) address (IRM); save the BSSID and the IRM as a current BSSID and a current IRM, the saved BSSID and the saved IRM being a saved combination; handle an exchange protocol with the station using the current BSSID and the current IRM, where the exchange protocol includes a next IRM and a next BSSID as the current IRM and current BSSID, respectively; disassociate the station; join the station to the current BSSID and the current IRM when the current IRM and current BSSID match the saved combination; save the BSSID and the IRM as the current BSSID and the current IRM, the saved BSSID and the saved IRM being the saved combination; handle an exchange protocol with the station using the current BSSID and current IRM, where the exchange protocol includes a next IRM and next BSSID as the current IRM and the current BSSID, respectively; and disassociate the station.

### EXAMPLE EMBODIMENTS

A station, after scanning and compiling the scan results, can elect to join a basic service set (BSS) of an AP discovered in the scan. The BSS may be part of an ESS that includes several BSSs and many stations. Joining one of the BSSs can include both authentication and association protocols.

Authentication requires that a station establish its identity before sending frames. In one embodiment, the station's identity is its MAC address. The station first sends an authentication request, which includes its identity, to an AP. After the initial request, a series of exchanges occur in which challenge text is sent to the station, and the station responds with a challenge text response. If the challenge response succeeds, the AP and station engage in a key exchange protocol, creating dynamic keys to encrypt traffic between the AP and station. In the key exchange, the station can provide a new identity.

Association includes a station sending an association request frame to the AP. The AP responds with an association response frame. As part of the response, the AP assigns an association ID.

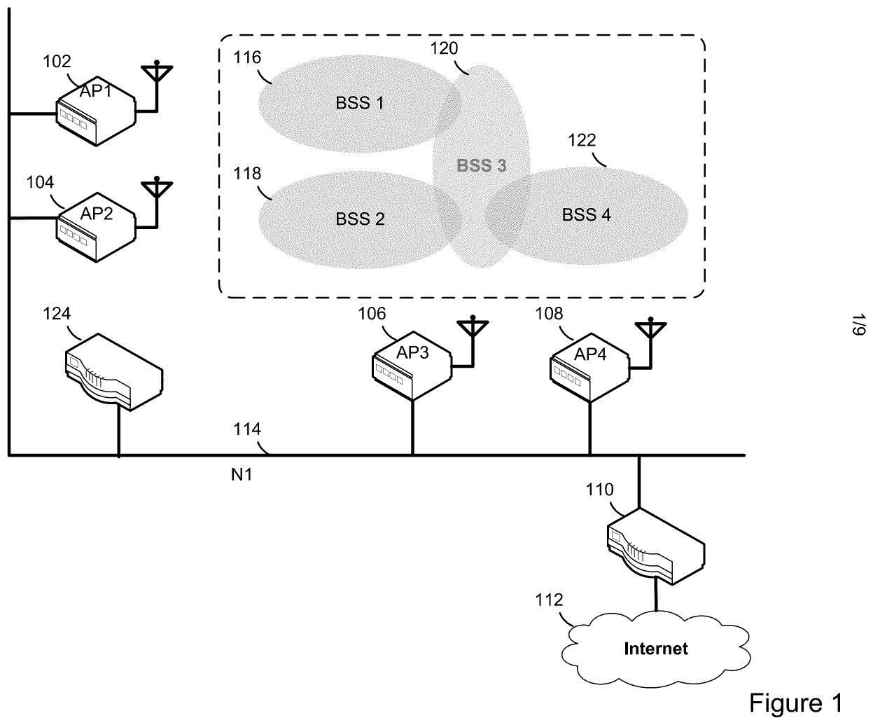

FIG. 1 depicts an ESS infrastructure, according to embodiments. The ESS includes AP 1 (102), 2 (104), 3 (106), and 4 (108), BSS 1 (116), 2 (118), 3 (120), and 4 (122), all coupled together with a wired network N1 114. The BSS is a group of stations that communicate with each other within a basic service area, and each station in a BSS has and maintains a unique IRM. The network N1 114 is coupled to a wireless LAN controller (WLC) 124 and a router 110, which in turn is coupled to the Internet 112.

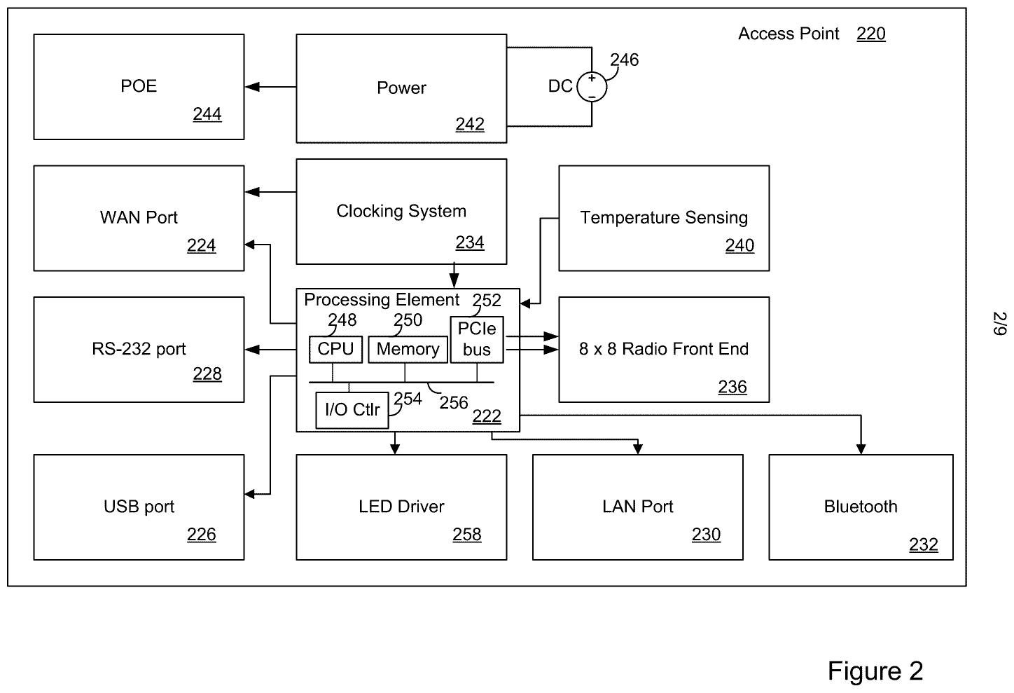

FIG. 2 depicts a representative architecture of an access point (AP), according to embodiments. The AP 220 includes a processing element 222 and several ports or connection facilities, such as a WAN port 224, USB port 226, RS-232 port 228, LAN port 230, and Bluetooth 232. Also included are a clocking system 234 and an 8×8 radio front-end 236 with a transmitter and receiver, which are coupled to eight external antennas. Auxiliary modules include a temperature sensing module 240, a power module 242 connected to a DC power source 246, a power over Ethernet (POE) module 244, and LED driver 258. The processing element 222 includes a CPU 248 and memory 250, a peripheral control interconnect express (PCle) bus controller 252 for connecting to the 8×8 radio front-end 236, and an I/O controller 254, all coupled to each other via bus 256. Memory 250 may include one or more buffers for traffic entering or exiting AP 220.

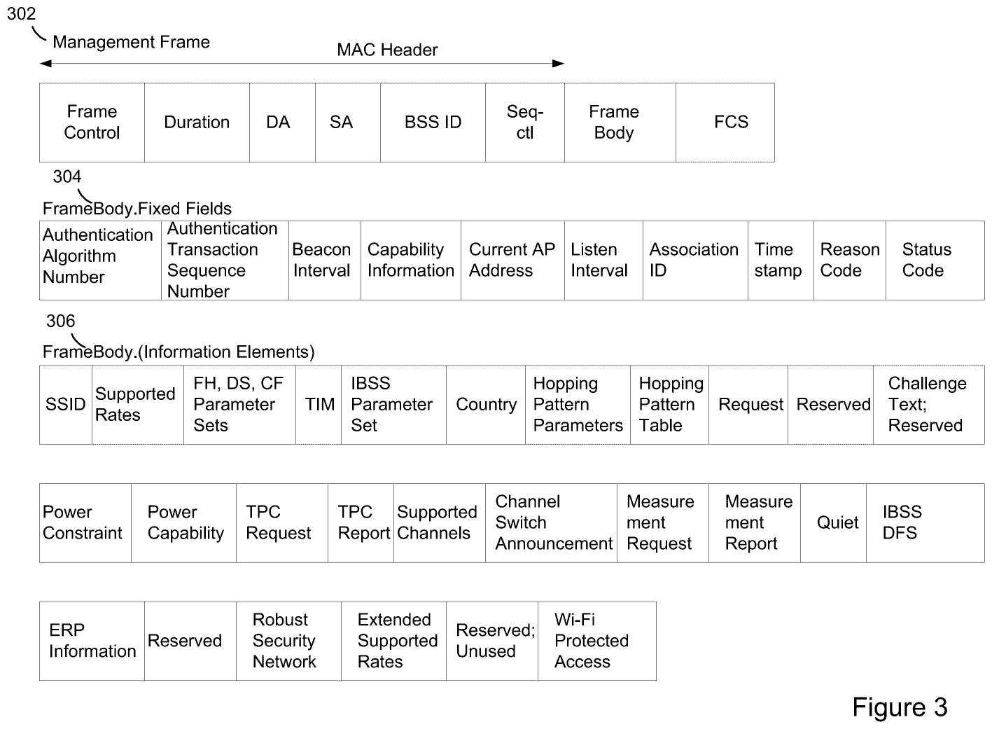

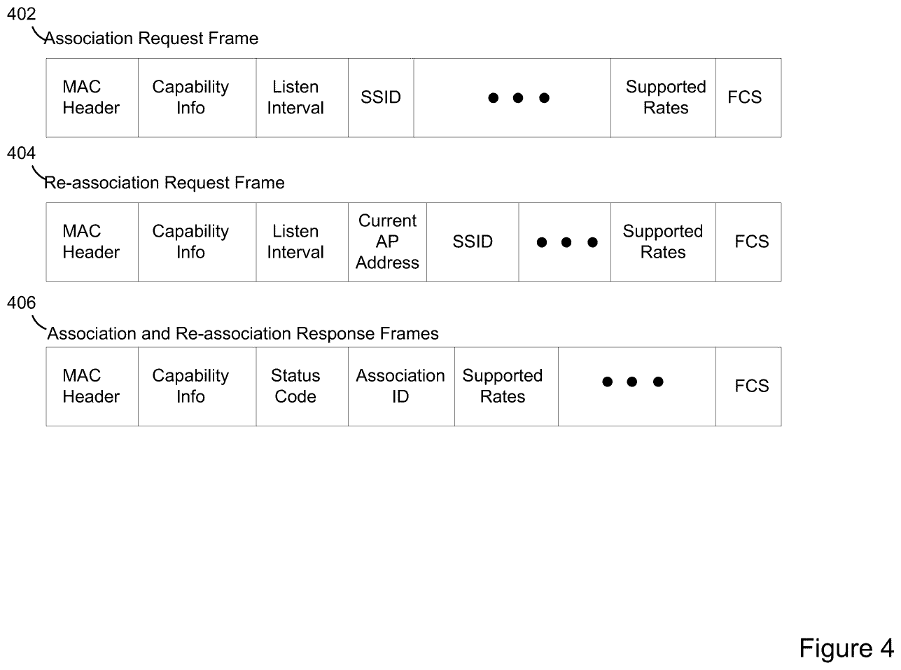

FIGS. 3 and 4 depict management frames, which include the authentication frames and association frames.

FIG. 3 depicts management frame 302, which includes a frame control field, a duration field, a destination address, a source address, an ID of a BSS, a sequence control field, a frame body, and a frame check sequence (FCS). The frame body includes a set of fixed fields 304 and a set of information elements 306. Important fixed fields include the current AP address, the authentication algorithm number, and the authentication transaction sequence number. Important information elements include challenge text used in the authentication.

FIG. 4 depicts association request and response frames. The association request frame 402, which is a type of management frame, includes a MAC header (depicted in FIG. 3), a capability info field, a listen interval field, a service set (SS) ID field, a supported rates field, and an FCS. The re-association request frame 404 is similar, except that a current AP address field is also included. The association and re-association response frames 406, also types of management frames, include a MAC header, a capability info field, a status code field, an association ID field, a supported rates field, and an FCS.

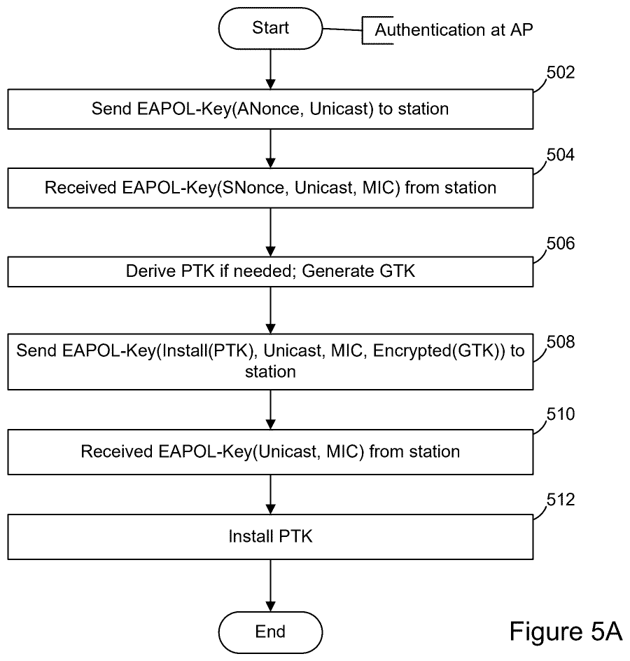

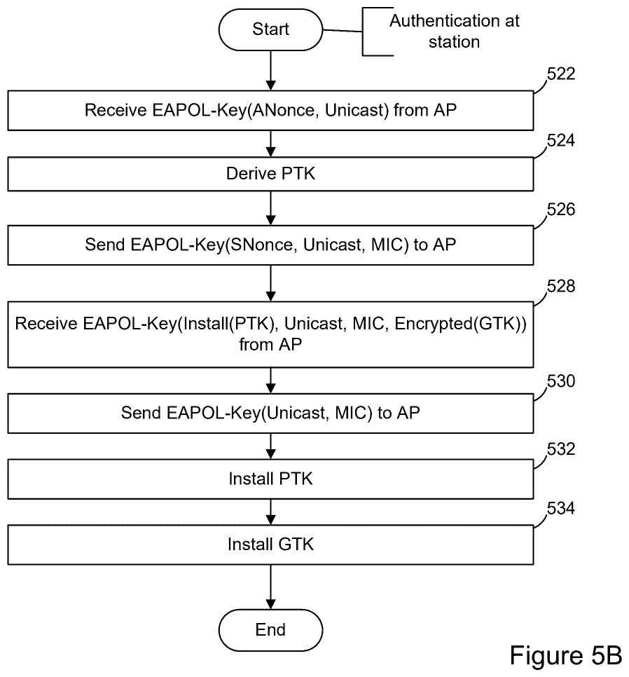

FIG. 5A depicts a flow of operations at the AP as part of the authentication protocol of a station with the AP, according to embodiments. This part of the authentication protocol involves a key exchange based on the MAC addresses of the AP and station. The key exchange uses a group temporal key (GTK) and a pairwise transient key (PTK). The GTK is used to encrypt all broadcast and multicast traffic between the AP and the station and is shared with all stations associated with the AP. The PTK is a key used to encrypt all unicast traffic between a particular station and the AP. The PTK is generated according to the following equation PTK=PRF (PMK+ANonce+SNonce+MAC(AA)+MAC(SA)), where PRF is a pseudo-random function applied to: ANonce, which is a random number generated by the AP, SNonce, which is a random number generated by the station, MAC(AA), which is the MAC address of the AP and MAC(SA), which is the MAC address of the station, and PMK, which is the pair wise master key and resides on all stations and the AP. The PMK is generated from the master session key (MSK), on which a group master key (GMK) also depends. The GTK is derived from the GMK and is generated on every access point and shared with stations connected to the AP.

In block 502, the AP sends a key (e.g., an extensible authentication protocol over LAN (EPOL) key with the ANonce to the station. In block 504, the AP receives the key with SNonce from the station and a message integrity check (MIC) to ensure the message is not corrupted. In block 506, the AP derives the PTK, if needed, and generates the GTK. In block 508, the AP sends the key with a command to install the PTK and the encrypted GTK to the station. In block 510, the AP receives the key from the station. In block 512, the AP installs the PTK. At this point, the station is allowed to send and receive frames on the network.

FIG. 5B depicts a flow of operations at the station as part of the authentication of a station with the AP, according to embodiments. In block 522, the station receives the EPOL-Key and the ANonce from the AP. In block 524, the station derives the PTK. In block 526, the station sends the key with the SNonce to the AP. In block 528, the station receives the key with the command to install the PTK and the encrypted GTK. In block 530, the station sends the key to the AP. In block 532, the station installs the PTK, and in block 534, the station installs the GTK. At this point, the AP and station can securely communicate.

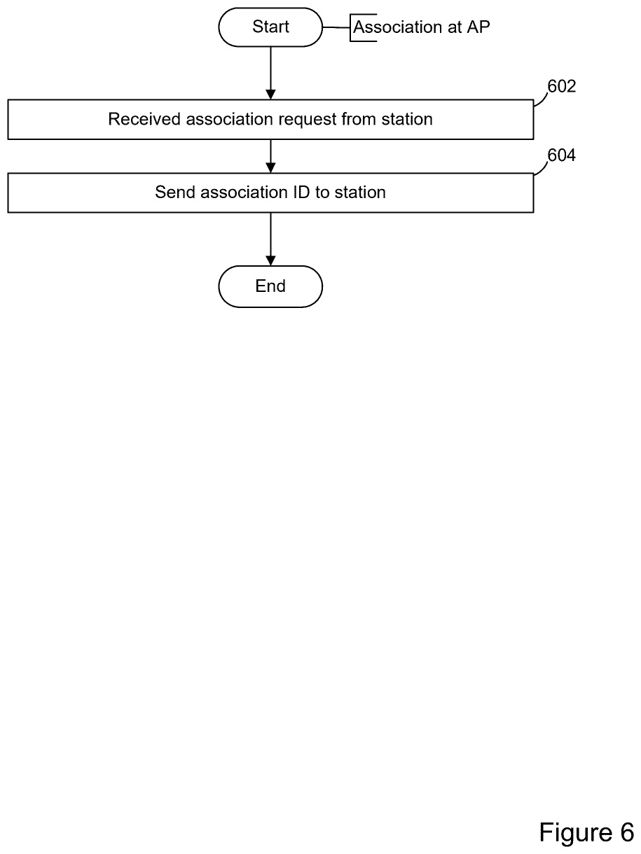

FIG. 6 depicts a flow of operations at the AP, according to embodiments. In block 602, the AP receives an association request frame. In block 604, the AP sends an association ID to the station in an association response frame.

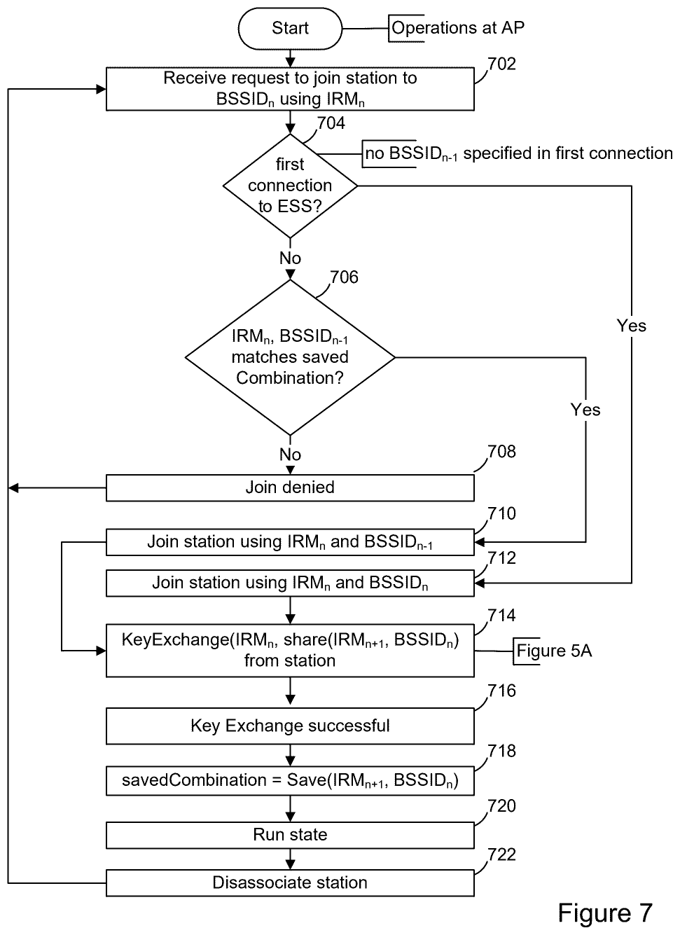

FIG. 7 depicts a flow of operations at the AP, according to embodiments. In block 702, the AP receives a request to join a station to a BSSIDₙ using IRMₙ. In block 704, the AP determines whether the station attempting to join is a first attempt or a subsequent attempt. If the attempt is a first attempt, then flow proceeds to block 712, in which the station joins using the IRMₙ and BSSIDₙ as there is no previous BSSIDₙ₋₁. The station also provides the ID of the previous AP to which it was joined if the first attempt is from roaming. If the attempt is a subsequent attempt, then flow proceeds to block 706, in which the IRMₙ and BSSIDₙ₋₁ are checked to determine if they match a saved combination of IRM and BSSID. In one embodiment, the AP performs the check. In another embodiment, the WLC 124 performs the check. If there is no match, then flow proceeds to block 708, in which the join request is denied. If there is a match, then flow proceeds to block 710, in which the AP joins the station using the IRMₙ and BSSIDₙ₋₁. Upon reaching either block 710 or block 712, flow proceeds to block 714 (according to FIG. 5A), in which a key exchange using IRMₙ and sharing IRMₙ₊₁ and BSSIDₙ occurs. In block 716, the key exchange successfully completes. In block 718, the saved combination is updated with IRMₙ₊₁ and BSSIDₙ. In block 720, the AP and station are in the run station, in which frames can be transmitted and received using the keys from the key exchange. In block 722, the AP disassociates the station, and flow resumes at block 702.

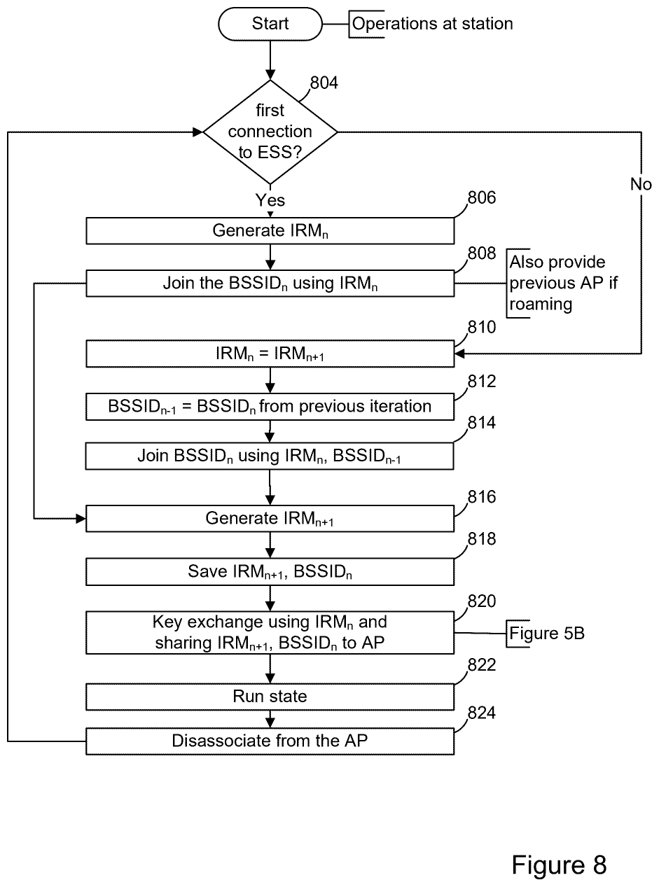

FIG. 8 depicts a flow of operations at a station, according to embodiments. In block 804, the station determines whether this is its first connection to the ESS. If so, flow proceeds to block 806, in which the station generates an IRMn. In block 808, the station joins BSSIDₙ using IRMₙ. If the station was previously connected to a different AP, then the station also provides the identity of the previous AP in block 808. Flow continues to block 816, in which the station generates IRMₙ₊₁ (i.e., the next IRM it will use to identify itself). In block 818, the station saves IRMₙ₊₁ and BSSIDₙ. In block 820, the station performs a key exchange (as depicted in FIG. 5B) using IRMₙ and shares IRMₙ₊₁ and BSSIDₙ with the AP. In block 822, the station and AP, in the run state, transmit and receive frames using the keys from the key exchange. In block 824, the station disassociates from the AP, and flow returns to block 804.

Continuing with FIG. 8, if the connection is not the first connection of the station to the ESS, then flow proceeds from block 804 to block 810, in which the station updates the current IRMₙ with the next IRMₙ₊₁ it will use to join with the BSS of the AP. In block 812, the station updates the BSSIDₙ from a previous iteration. In block 814, the station joins the BSSIDₙ using IRMₙ and BSSIDₙ₋₁. The flow then proceeds with blocks 816, 818, 820, and 822, as described above.

An example flow is as follows. Let the current BSSIDₙ=BSSID1 and the current IRMₙ=IRM1. The station joins with the AP using BSSID1 and IRM1. The station then generates the next IRMₙ₊₁=IRM2 and saves IRM2 and BSSID1. The station then performs a key exchange using IRM1, shares IRM2 and BSSID1, and disassociates from the AP. Next, the station updates the current IRMₙ to IRM2, the current BSSID to BSSID1, and joins the BSSID1 using IRM2 and BSSID1. After joining, the station generates its next IRMₙ₊₁=IRM3 and saves IRM3 and BSSID1. The station performs another key exchange with IRM2, shares IRM3 and BSSID1, runs, and disassociates.

Thus, on every subsequent connection with the AP, the station can use a different IRM to identify itself. Only the combination of the current IRM and current BSSID for which there was a previous key exchange will allow the station to communicate with the AP.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment does not limit the scope of the present disclosure. Thus, the aspects, features, embodiments, and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.), or an embodiment combining software and hardware aspects that may all generally be referred to herein as a “circuit,” “module” or “system.” Furthermore, embodiments may take the form of a computer program product embodied in one or more computer-readable medium(s) having computer readable program code embodied thereon.

Program code embodied on a computer-readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object-oriented programming language such as Java, Smalltalk, C++or the like, and conventional procedural programming languages, such as the “C” programming language or similar programming languages. The program code may execute entirely on the user's computer, partly on the user's computer, as a stand-alone software package, partly on the user's computer, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams and combinations of blocks in the flowchart illustrations and/or block diagrams, can be implemented by computer program instructions. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer-readable medium (possibly non-transitory) that can direct a computer, other programmable data processing apparatus, or other device to function in a particular manner, such that the instructions stored in the computer-readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer-implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method of identifying a station in an extended service set (ESS), the method comprising:
joining the station to a basic service set (BSS) of an access point (AP) using an ID of the BSS (BSSID) and an identifiable random access medium access layer (MAC) address (IRM);
saving the BSSID and the IRM as a current BSSID and a current IRM, the saved BSSID and the saved IRM being a saved combination;
handling an exchange protocol with the station using the current BSSID and the current IRM, wherein the exchange protocol includes a next IRM and a next BSSID as the current IRM and current BSSID, respectively;
disassociating the station;
joining the station to the current BSSID and the current IRM when the current IRM and current BSSID match the saved combination;
saving the BSSID and the IRM as the current BSSID and the current IRM, the saved BSSID and the saved IRM being the saved combination;
handling an exchange protocol with the station using the current BSSID and current IRM, wherein the exchange protocol includes a next IRM and next BSSID as the current IRM and the current BSSID, respectively; and
disassociating the station.

2. The method of claim 1, wherein the next BSSID is a BSSID that is different from the current BSSID.

3. The method of claim 1,
wherein the extended service set includes a wireless LAN controller (WLC); and
wherein determining when the current IRM and current BSSID match the saved combination is performed by the WLC.

4. The method of claim 1, wherein joining includes providing an ID of the BSS of a previous AP with which the station was joined.

5. The method of claim 1,
wherein the extended service set includes a plurality of BSSs; and
wherein an ID of each BSS in the extended service set is associated with a unique IRM.

6. The method of claim 1, wherein the exchange protocol is a key exchange protocol.

7. The method of claim 1, wherein receiving a request to join includes receiving an association request frame.

8. An access point (AP) in an extended service set (ESS), the AP comprising:
a processor; and
a memory coupled to the processor and having loaded therein a program executable by the processor to:
join a station to a basic service set (BSS) of an access point (AP) using an ID of the BSS (BSSID) and an identifiable random access medium access layer (MAC) address (IRM);
save the BSSID and the IRM as a current BSSID and a current IRM, the saved BSSID and the saved IRM being a saved combination;
handle an exchange protocol with the station using the current BSSID and the current IRM, wherein the exchange protocol includes a next IRM and a next BSSID as the current IRM and current BSSID, respectively;
disassociate the station;
join the station to the current BSSID and the current IRM when the current IRM and the current BSSID match the saved combination;
save the BSSID and the IRM as the current BSSID and the current IRM, the saved BSSID and the saved IRM being the saved combination;
handle an exchange protocol with the station using the current BSSID and current IRM, wherein the exchange protocol includes a next IRM and next BSSID as the current IRM and the current BSSID, respectively; and
disassociate the station.

9. The access point of claim 8, wherein the next BSSID is a BSSID different from the current BSSID.

10. The access point of claim 8,
wherein the extended service set includes a wireless LAN controller (WLC); and
wherein determining when the current IRM and current BSSID match the saved combination is performed by the WLC.

11. The access point of claim 8, wherein being executable to join includes providing an ID of the BSS of a previous AP with which the station was joined.

12. The access point of claim 8,
wherein the extended service set includes a plurality of BSSs; and
wherein an ID of each BSS in the extended service set is associated with a unique IRM.

13. The access point of claim 8, wherein the exchange protocol is a key exchange protocol.

14. The access point of claim 8, wherein being executable to join includes being executable to receive an association request frame.

15. A non-transitory computer-readable medium encoding instructions, which, when executed by a processor of an access point (AP) coupled to a wireless medium, cause the AP to:
join a station to a basic service set (BSS) of an access point (AP) in an extended service set using an ID of the BSS (BSSID) and an identifiable random access medium access layer (MAC) address (IRM);
save the BSSID and the IRM as a current BSSID and a current IRM, the saved BSSID and the saved IRM being a saved combination;
handle an exchange protocol with the station using the current BSSID and the current IRM, wherein the exchange protocol includes a next IRM and a next BSSID as the current IRM and current BSSID, respectively;
disassociate the station;
join the station to the current BSSID and the current IRM when the current IRM and current BSSID match the saved combination;
save the BSSID and the IRM as the current BSSID and the current IRM, the saved BSSID and the saved IRM being the saved combination;
handle an exchange protocol with the station using the current BSSID and current IRM, wherein the exchange protocol includes a next IRM and next BSSID as the current IRM and the current BSSID, respectively; and
disassociate the station.

16. The non-transitory computer-readable medium of claim 15, wherein the next BSSID is a BSSID that is different from the current BSSID.

17. The non-transitory computer-readable medium of claim 15,
wherein the extended service set includes a wireless LAN controller (WLC); and
wherein determining when the current IRM and current BSSID match the saved combination is performed by the WLC.

18. The non-transitory computer-readable medium of claim 15, wherein causing the AP to join includes causing the AP to provide an ID of the BSS of a previous AP with which the station was joined.

19. The non-transitory computer-readable medium of claim 15,
wherein the extended service set includes a plurality of BSSs; and
wherein an ID of each BSS in the extended service set is associated with a unique IRM.

20. The non-transitory computer-readable medium of claim 15, wherein the exchange protocol is a key exchange protocol.
